(19) United States
(12) Patent Application Publication
(10) Pub. No.: US 2025/0246861 A1
(43) Pub. Date: Jul. 31, 2025

(54) COAXIAL CONNECTOR AND CONNECTOR ASSEMBLY COMPRISING THE SAME

(71) Applicant: JAPAN AVIATION ELECTRONICS INDUSTRY, LIMITED, Tokyo (JP)

(72) Inventors: Keisuke NAKAMURA, Tokyo (JP); Kenta ASHIBU, Tokyo (JP); Osamu HASHIGUCHI, Tokyo (JP)

(73) Assignee: JAPAN AVIATION ELECTRONICS INDUSTRY, LIMITED, Tokyo (JP)

(21) Appl. No.: 18/977,081

(22) Filed: Dec. 11, 2024

(30) Foreign Application Priority Data
Jan. 29, 2024 (JP) 2024-011170

(51) Int. Cl. H01R 24/50

(52) U.S. Cl. CPC H01R 24/50

(57) ABSTRACT

A coaxial connector comprises a center terminal and an outer terminal which has a projecting portion and an end surface. The projecting portion projects forward from the end surface and has a pressing portion which is located at a lower end of the projecting portion. The center terminal has a contact portion. Under a pre-connected state where the coaxial connector is not yet connected to a board, the contact portion extends forward and downward so that at least a part of the contact portion is located forward of the end surface and is located below the pressing portion. Under a connected state where the coaxial connector is connected to the board, the pressing portion presses an upper surface of the board from above, and at least a part of the contact portion is pressed against a signal line of the board to be in contact with the signal line.

### CROSS REFERENCE TO RELATED APPLICATIONS

This application is based on and claims priority under 35 U.S.C. § 119 to Japanese Patent Application No. JP 2024-011170 filed Jan. 29, 2024, the content of which is incorporated herein in its entirety by reference.

### BACKGROUND OF THE INVENTION

This invention relates to a coaxial connector configured to be attached to a coaxial cable and to be connected to a board.

For example, this type of coaxial connector is disclosed in JP2009-064588A (Patent Document 1), the content of which is incorporated herein by reference.

Referring to FIG. 19, Patent Document 1 discloses a coaxial connector 90 fixed to a case 94. The case 94 is provided with a board 96 located therein. The board 96 is formed with a transmission line (signal line) 98. The coaxial connector 90 comprises a terminal portion (center terminal) 92. The center terminal 92 is electrically connected with the signal line 98 of the circuit board 96. The electrical connection as described above is usually performed by soldering the center terminal 92 to the signal line 98.

There is a demand for electrically connecting the coaxial connector with a board without soldering.

### SUMMARY OF THE INVENTION

It is therefore an object of the present invention to provide a coaxial connector configured to be connected to a board by a new method other than the soldering.

An aspect of the present invention provides a coaxial connector configured to be attached to a coaxial cable and to be connected to a board. The board extends along a horizontal plane and has an upper surface in an up-down direction perpendicular to the horizontal plane, the upper surface is formed with a signal line, and the signal line extends in a front-rear direction perpendicular to the up-down direction. The coaxial connector comprises an outer terminal, a center terminal and an insulation member. The insulation member insulates the outer terminal and the center terminal from each other. The outer terminal is formed with a receiving portion. The receiving portion is configured to receive a front end of the coaxial cable along a predetermined direction which extends forward and downward. The outer terminal has a projecting portion and an end surface. The projecting portion projects forward from the end surface and has a pressing portion. The pressing portion is located at a lower end of the projecting portion. The center terminal has a contact portion and a connection portion. The contact portion and the connection portion are arranged on a single straight line which extends along the predetermined direction. The contact portion is resiliently deformable. The connection portion is configured to be connected to the coaxial cable. Under a pre-connected state where the coaxial connector is not yet connected to the board, the contact portion extends along the predetermined direction so that at least a part of the contact portion is located forward of the end surface and is located below the pressing portion. Under a connected state where the coaxial connector is fixed and connected to the board, the pressing portion presses the upper surface of the board from above, and the contact portion is bent so that at least a part of the contact portion extends in a direction which intersects with the predetermined direction and is pressed against the signal line of the board to be in contact with the signal line.

Another aspect of the present invention provides a connector assembly comprising the coaxial connector, a plate and a fixing member. Under the connected state, the fixing member fixes the projecting portion and the plate to each other so that the board is sandwiched and held between the projecting portion and the plate in the up-down direction.

According to an aspect of the present invention, the contact portion of the center terminal under the pre-connected state extends downward beyond the pressing portion. The pressing portion presses the upper surface of the board from above under the connected state. According to the arrangement described above, the signal line of the board can be arranged at a position same as that of the pressing portion in the up-down direction under the connected state, and thereby the contact portion is pressed against the signal line to be in contact with the signal line while being bent. Thus, an aspect of the invention provides a coaxial connector configured to be connected to a board by a new method other than the soldering.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is an exploded, perspective view showing a structure according to an embodiment of the present invention, wherein a connector assembly of the structure is under a pre-connected state where its coaxial connector is not yet connected to a board, and an outline of a coaxial cable is schematically illustrated with dashed line.

FIG. 2 is a front view showing the coaxial connector of the connector assembly of FIG. 1, wherein outlines of hidden screw holes are illustrated with dashed line.

FIG. 3 is a cross-sectional view showing the coaxial connector of FIG. 2, taken along line III-III, wherein an outline of the coaxial cable is schematically illustrated with dashed line.

FIG. 4 is a perspective view showing the structure of FIG. 1, wherein the connector assembly of the structure is under a connected state where the coaxial connector is connected to the board, and an outline of the coaxial cable is schematically illustrated with dashed line.

FIG. 5 is a top view showing the structure of FIG. 4.

FIG. 6 is a side view showing the structure of FIG. 4, wherein an outline of a recessed portion which is not provided in the present embodiment is illustrated with dashed line.

FIG. 7 is a front view showing the structure of FIG. 4, wherein outlines of hidden screw holes, hidden fixing holes and hidden passing holes are illustrated with dashed line.

FIG. 8 is a cross-sectional view showing the structure of FIG. 7, taken along line VIII-VIII, wherein cross-sections of the coaxial cable and a mating connector are schematically illustrated with dashed line.

FIG. 9 is a cross-sectional view showing a part of the structure enclosed by two-dot chain line of FIG. 8, wherein an outline of a contact portion of a center terminal under the pre-connected state is illustrated with dashed line, and an outline of an additional portion of the center terminal is illustrated with chain dotted line.

FIG. 10 is an exploded, perspective view showing a first modification of the structure of FIG. 1, wherein a connector assembly of the structure is under a pre-connected state where its coaxial connector is not yet connected to the board, and an outline of the coaxial cable is schematically illustrated with dashed line.

FIG. 11 is a front view showing the coaxial connector of the connector assembly of FIG. 10.

FIG. 12 is a cross-sectional view showing the coaxial connector of FIG. 11, taken along line XII-XII, wherein a part of the coaxial connector enclosed by dashed line is enlarged and illustrated.

FIG. 13 is a cross-sectional view showing the structure of FIG. 10, wherein the illustrated cross-section corresponds to the cross-section of FIG. 12, the connector assembly of the structure is under a connected state where the coaxial connector is connected to the board, and a part of the structure enclosed by dashed line is enlarged and illustrated.

FIG. 14 is an exploded, perspective view showing a second modification of the structure of FIG. 1, wherein a connector assembly of the structure is under a pre-connected state where its coaxial connector is not yet connected to the board.

FIG. 15 is an exploded, perspective view showing the coaxial connector of the connector assembly of FIG. 14.

FIG. 16 is a top view showing the structure of FIG. 14, wherein the connector assembly of the structure is under a connected state where the coaxial connector is connected to the board.

FIG. 17 is a cross-sectional view showing the structure of FIG. 16, taken along line XVII-XVII, wherein a part of the structure enclosed by dashed line is enlarged and illustrated.

FIG. 18 is a cross-sectional view showing the coaxial connector of the connector assembly of FIG. 17, wherein the coaxial connector is under a pre-connected state where the coaxial connector is not yet connected to the board, and a part of the coaxial connector enclosed by dashed line is enlarged and illustrated.

FIG. 19 is a perspective view showing a coaxial connector, a case and a board of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

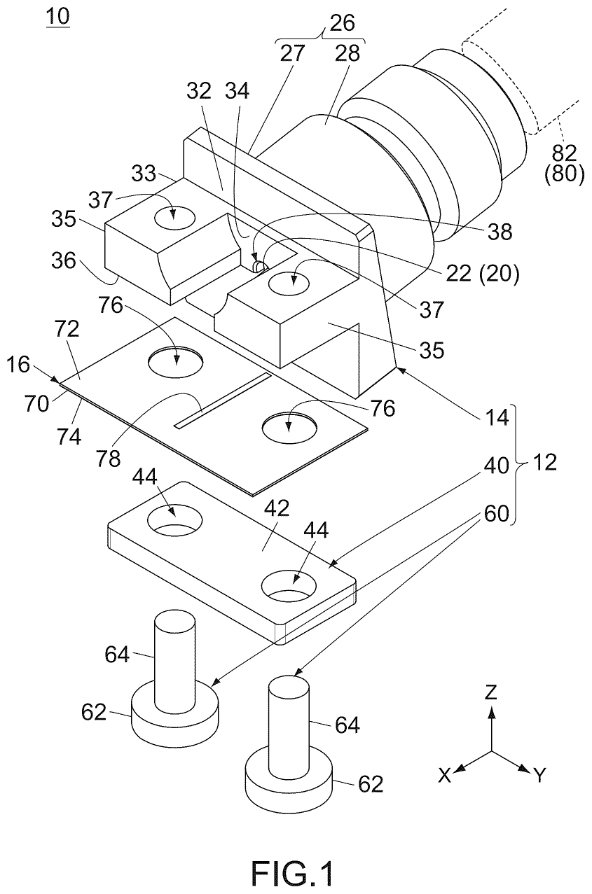

As shown in FIG. 1, a structure 10 according to an embodiment of the present invention comprises a connector assembly 12 and a board 16. The structure 10 of the present embodiment is an antenna structure. However, the present invention is not limited thereto but is applicable to various structures. Moreover, the structure 10 may further comprise another member in addition to the aforementioned members.

The connector assembly 12 of the present embodiment comprises a coaxial connector 14, a plate 40 made of metal and two fixing members (screws) 60 each made of metal. However, the present invention is not limited thereto. For example, the connector assembly 12 may comprise only the coaxial connector 14. Instead, the connector assembly 12 may further comprise another member in addition to the aforementioned members.

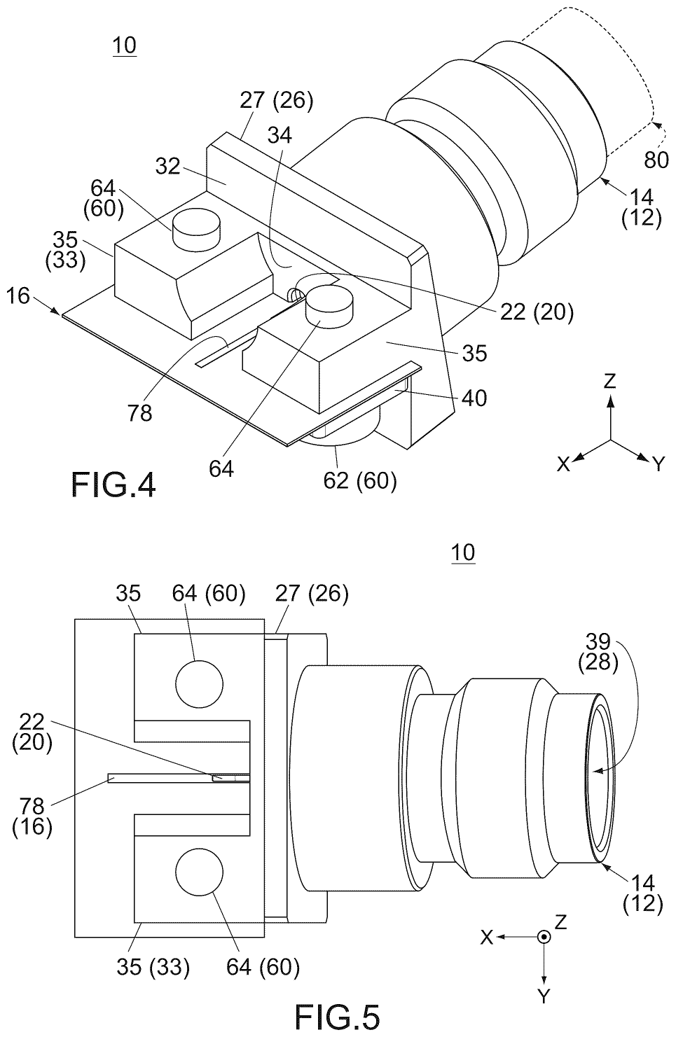

Referring to FIGS. 1 and 4, the board 16 extends along a horizontal plane. The coaxial connector 14 is configured to be connected to the board 16. Thus, the connector assembly 12 is configured to be connected to the board 16. In detail, the connector assembly 12 is configured to be connected to a rear end of the board 16 in a front-rear direction in parallel to the horizontal plane.

The horizontal plane of the present embodiment is the XY-plane. The front-rear direction of the present embodiment is the X-direction. In the present embodiment, “forward” means the positive X-direction, and “rearward” means the negative X-direction. The words such as the horizontal plane and the front-rear direction do not indicate the absolute positional relation relative to the ground but merely indicate a relative positional relation under a definition where the board 16 extends in the horizontal plane when not bent at all, and where the connector assembly 12 is located forward of this board 16.

Hereafter, explanation will be made about the board 16 of the present embodiment.

Referring to FIG. 1, the board 16 of the present embodiment is a flexible board and comprises a base 70 which is formed of a thin film-like insulator. The board 16 comprises only the base 70 except for various conductive patterns formed on the base 70. The thus-formed board 16 is easily bent and can be flexibly arranged in a narrow space in an apparatus (not shown). However, the present invention is not limited thereto. For example, the board 16 may be a rigid circuit board which is thick and is hardly bent.

The board 16 has an upper surface 72 and a lower surface 74 in an up-down direction perpendicular to the horizontal plane. The upper surface 72 and the lower surface 74 are located at an upper end and a lower end of the base 70, respectively. The up-down direction of the present embodiment is the Z-direction. In the present embodiment, “upward” means the positive Z-direction, and “downward” means the negative Z-direction.

The board 16 is formed with two passing holes 76. Each of the passing holes 76 passes through the board 16 in the up-down direction. Each of the passing holes 76 has a circular shape in the horizontal plane. The thus-formed passing holes 76 are used when the connector assembly 12 is screwed to the board 16 as described later. The two passing holes 76 are apart from each other in a lateral direction perpendicular to both the front-rear direction and the up-down direction and are located at positions same as each other in the front-rear direction. The lateral direction of the present embodiment is the Y-direction.

The passing holes 76 of the present embodiment are formed as described above. However, the present invention is not limited thereto. For example, the shape of each of the passing holes 76 is not specifically limited. The number of the passing holes 76 may be one, three or more. In an instance in which the number of the passing holes 76 is three or more, two of the passing holes 76 may be apart from each other in the lateral direction and may be located at positions same as each other in the front-rear direction.

The upper surface 72 of the board 16 is formed with a signal line 78 which is a conductive pattern. The signal line 78 extends in the front-rear direction perpendicular to the up-down direction and is located between the two passing holes 76 in the lateral direction. The lower surface 74 of the board 16 is formed with a ground layer (not shown) which is another conductive pattern and covers the whole of the lower surface 74.

The signal line 78 is connected to an antenna which is formed on an unillustrated front end part of the board 16, for example. The coaxial connector 14 connected to the board 16 transmits signals to the antenna through the signal line 78. The thus-transmitted signals are sent outward from the antenna. On the other hand, signals received by the antenna are transmitted to the connector assembly 12 through the signal line 78. The structure 10 of the present embodiment is used as described above, for example. However, the usage of the structure 10 of the present invention is not specifically limited. The structure 10 of the present invention may be any electric device with the board 16.

The board 16 of the present embodiment has the aforementioned configuration. However, the configuration of the board 16 can be modified in accordance with the usage of the structure 10. For example, the ground layer (not shown) may be partially formed on the lower surface 74.

Hereafter, explanation will be made about the coaxial connector 14 of the present embodiment.

Referring to FIGS. 1 and 4, the coaxial connector 14 of the present embodiment is a so-called sub miniature type A (SMA) connector. However, the present invention is not only applicable to the coaxial connector 14 of the present embodiment but also applicable to various coaxial connectors.

The coaxial connector 14 is configured to be attached to the coaxial cable 80 and to be connected to the board 16. The coaxial connector 14 and the connector assembly 12 of FIG. 4 are under a connected state where the coaxial connector 14 is fixed and connected to the board 16. The coaxial connector 14 and the connector assembly 12 of FIG. 1 are under a pre-connected state where the coaxial connector 14 is not yet connected to the board 16.

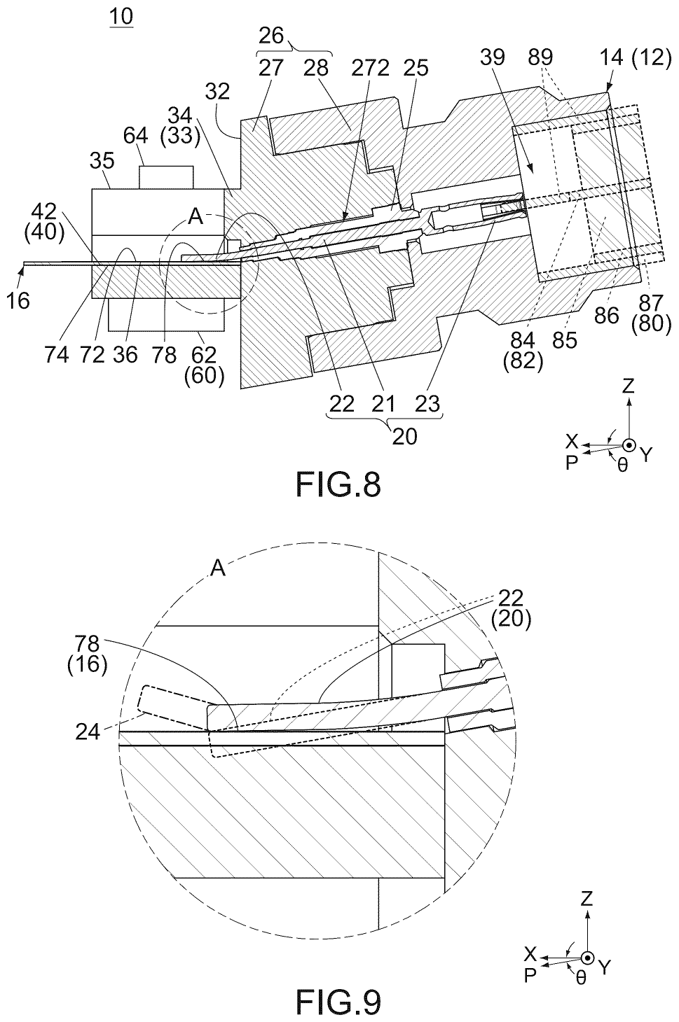

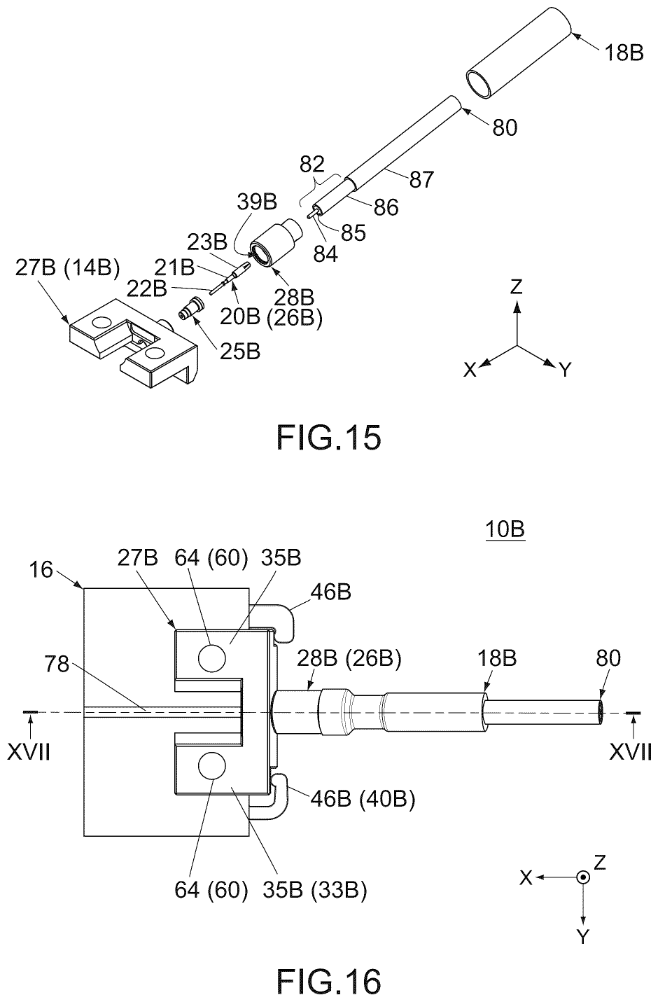

Referring to FIG. 3 together with FIGS. 8 and 15, the coaxial cable 80 illustrated with dashed line in FIGS. 3 and 8 is a typical coaxial cable and comprises a core wire 84 made of conductor, an inner insulator 85 made of insulator and covering the core wire 84, a shield 86 made of conductor and covering the inner insulator 85 and a sheath 87 made of insulator and covering the shield 86. The number of the core wire 84 of the present embodiment is one. However, the configuration of the coaxial cable 80 is not specifically limited.

Referring to FIG. 3 together with FIG. 8, the coaxial cable 80 is configured to be attached to a rear end of the coaxial connector 14. According to the present embodiment, the coaxial cable 80 is configured to be attached to the rear end of the coaxial connector 14 via a mating connector 89 attached to the coaxial cable 80. However, the present invention is not limited thereto. For example, the coaxial cable 80 may be configured to be directly attached to the rear end of the coaxial connector 14.

Referring to FIG. 3 together with FIG. 1, the coaxial connector 14 of the present embodiment comprises a center terminal 20 made of conductor, an insulation member 25 made of insulator and an outer terminal 26 made of conductor. The coaxial connector 14 of the present embodiment comprises only the aforementioned members. However, the present invention is not limited thereto. For example, the coaxial connector 14 may further comprise another member in addition to the aforementioned members.

The outer terminal 26 of the present embodiment comprises a front conductive member 27 and a rear conductive member 28. The front conductive member 27 is combined with the rear conductive member 28 and is located forward of the rear conductive member 28. The front conductive member 27 is in contact with the rear conductive member 28. The outer terminal 26 of the present embodiment consists of the aforementioned two members. However, the present invention is not limited thereto, but the configuration of the outer terminal 26 can be variously modified. For example, the front conductive member 27 and the rear conductive member 28 may be a member integrally formed with each other. The outer terminal 26 may further comprise another member in addition to the front conductive member 27 and the rear conductive member 28.

As shown in FIGS. 3 and 8, the outer terminal 26 is formed with a receiving portion 39. The receiving portion 39 of the present embodiment is formed in the rear conductive member 28. The receiving portion 39 is a space which opens rearward. The receiving portion 39 extends along a predetermined direction which extends forward and downward. The receiving portion 39 is configured to receive a front end 82 of the coaxial cable 80 along the predetermined direction. According to the present embodiment, the mating connector 89 attached to the coaxial cable 80 is fit into the receiving portion 39 along the predetermined direction, and thereby the coaxial cable 80 is indirectly received in the receiving portion 39 via the mating connector 89. The predetermined direction of the present embodiment is a mating direction along which the coaxial connector 14 is configured to be mated with the mating connector 89. However, the present invention is not limited thereto. For example, the coaxial cable 80 may be directly received in the receiving portion 39.

The predetermined direction of the present embodiment is a P-direction which is oblique to each of the up-down direction and the front-rear direction. In the present embodiment, the intersection angle θ between the predetermined direction and the front-rear direction is about ten degrees. However, the intersection angle θ of the present invention is not specifically limited. For example, the intersection angle θ may be five degrees or more.

The rear conductive member 28 of the outer terminal 26 is electrically connected with the shield 86 of the coaxial cable 80 when the coaxial cable 80 is received in the receiving portion 39. The outer terminal 26 and the shield 86 connected to each other have ground potentials same as each other.

The center terminal 20 of the present embodiment extends along the predetermined direction (P-direction) and has a body 21, a contact portion 22 and a connection portion 23. The contact portion 22 and the connection portion 23 are arranged on a single straight line which is an imaginary straight line and extends along the predetermined direction. The body 21, the contact portion 22 and the connection portion 23 of the present embodiment are integrally formed with each other. In other words, each of the body 21, the contact portion 22 and the connection portion 23 is a part of the single center terminal 20.

The body 21 is located at the middle of the center terminal 20 in the predetermined direction (P-direction). The connection portion 23 has a socket shape and extends to the body 21 along the predetermined direction. The body 21 extends from the connection portion 23 to the contact portion 22 along the predetermined direction. The contact portion 22 extends from the body 21 along the predetermined direction. The center terminal 20 of the present embodiment has the aforementioned portions. However, the present invention is not limited thereto. For example, the center terminal 20 may be formed of two members which are formed separately from each other and then connected to each other. The connection method of these two members is not specifically limited. For example, these two members may be fixed and connected to each other by a method such as welding or soldering. Instead, one of these members may be a pin-like member, and a remaining one of these members may be a socket-like member. In this instance, the pin-like member may resiliently deform the socket-like member so that these two members are in contact and electrically connected with each other. Moreover, the center terminal 20 may further have another portion in addition to the aforementioned portions.

The body 21 of the present embodiment has a circular shape in a predetermined plane perpendicular to the predetermined direction (P-direction). The contact portion 22 is resiliently deformable. In detail, the contact portion 22 of the present embodiment has a circular shape which is smaller than that of the body 21 in the predetermined plane and is resiliently deformed easily by any force along the predetermined plane. The predetermined plane of the present embodiment is a plane which is oblique to the front-rear direction and is in parallel to the lateral direction. The center terminal 20 of the present embodiment has the aforementioned shape. However, the present invention is not limited thereto. For example, the shape of the contact portion 22 in the predetermined plane perpendicular to the predetermined direction may be elliptical or polygonal.

The connection portion 23 is configured to be connected to the coaxial cable 80. In detail, the connection portion 23 is electrically connected with the core wire 84 of the coaxial cable 80 when the coaxial cable 80 is received in the receiving portion 39. The connection portion 23 may be indirectly connected to the core wire 84 via a pin terminal of the mating connector 89. Instead, the connection portion 23 may be directly connected to the core wire 84. The center terminal 20 and the core wire 84 connected to each other transmit signals to each other.

The insulation member 25 of the present embodiment encloses the body 21 of the center terminal 20 in the predetermined plane perpendicular to the predetermined direction (P-direction). The outer terminal 26 encloses the connection portion 23 in the predetermined plane with a distance formed therebetween. The outer terminal 26 also encloses the body 21 with the insulation member 25 located therebetween in the predetermined plane. The thus-arranged insulation member 25 is located between the center terminal 20 and the outer terminal 26 in the predetermined plane and insulates the outer terminal 26 and the center terminal 20 from each other.

The center terminal 20 of the present embodiment is covered by the insulation member 25 as described above. The center terminal 20 and the insulation member 25 extend straight along the predetermined direction (P-direction). The front conductive member 27 is formed with an attachment hole 272 which extends straight along the predetermined direction. Thus, the outer terminal 26 of the present embodiment is formed with the attachment hole 272. The attachment hole 272 opens forward and rearward of the front conductive member 27. According to this configuration, the coaxial connector 14 can be fabricated as described below. Firstly, the center terminal 20 and the rear conductive member 28 are connected to the coaxial cable 80. Then, the center terminal 20 and the insulation member 25 are inserted into the attachment hole 272 along the predetermined direction. The thus-inserted center terminal 20 is received and attached in the attachment hole 272 so as to extend along the predetermined direction.

According to the aforementioned fabrication method, the coaxial connector 14 can be easily fabricated. The center terminal 20 and the insulation member 25 have a point symmetrical shape in the predetermined plane perpendicular to the predetermined direction (P-direction), and this shape enables easy fabrication of the coaxial connector 14. However, the configuration of the center terminal 20 can be modified as necessary, provided that the center terminal 20 has the contact portion 22 which extends along the predetermined direction.

The center terminal 20, the insulation member 25 and the outer terminal 26 of the present embodiment are arrange as described above. According to the center terminal 20 of the present embodiment, the body 21 is a part covered by the insulation member 25, and each of the contact portion 22 and the connection portion 23 is another part exposed from the insulation member 25. However, the configuration and the arrangement of the center terminal 20, the insulation member 25 and the outer terminal 26 are not specifically limited.

As shown in FIGS. 1 to 3, the outer terminal 26 has a projecting portion 33 and an end surface 32. The end surface 32 of the present embodiment is a front surface of the front conductive member 27 and a rectangular flat surface in parallel to a vertical plane (YZ-plane). The projecting portion 33 is located at the middle of the end surface 32 in the up-down direction and extends over all the end surface 32 in the lateral direction.

The projecting portion 33 projects forward from the end surface 32. In detail, the projecting portion 33 of the present embodiment has a middle projecting portion 34 and two side projecting portions 35. The middle projecting portion 34 is located at the middle of the projecting portion 33 in the lateral direction and projects forward from the end surface 32. The two side projecting portions 35 are located at opposite sides of the middle projecting portion 34 in the lateral direction, respectively. Each of the side projecting portions 35 projects forward from an end of the projecting portion 33 in the lateral direction beyond a front end of the middle projecting portion 34. The thus-arranged two side projecting portions 35 are apart from each other in the lateral direction and project forward from the end surface 32.

The projecting portion 33 of the present embodiment has the aforementioned configuration. However, the present invention is not limited thereto, but the configuration of the projecting portion 33 can be variously modified. For example, each of the middle projecting portion 34 and the side projecting portions 35 may be provided as necessary.

The two side projecting portions 35 of the present embodiment have a mirror symmetric shape with respect to a perpendicular plane (XZ-plane). The thus-arranged two side projecting portions 35 are located at positions same as each other in the up-down direction. Each of the side projecting portions 35 has a flat-plate shape in parallel to the horizontal plane and has an upper surface and a lower surface each of which is in parallel to the horizontal plane. The number of the side projecting portions 35 of the present embodiment is two. However, the present invention is not limited thereto. For example, the number of the side projecting portions 35 may be one, three or more.

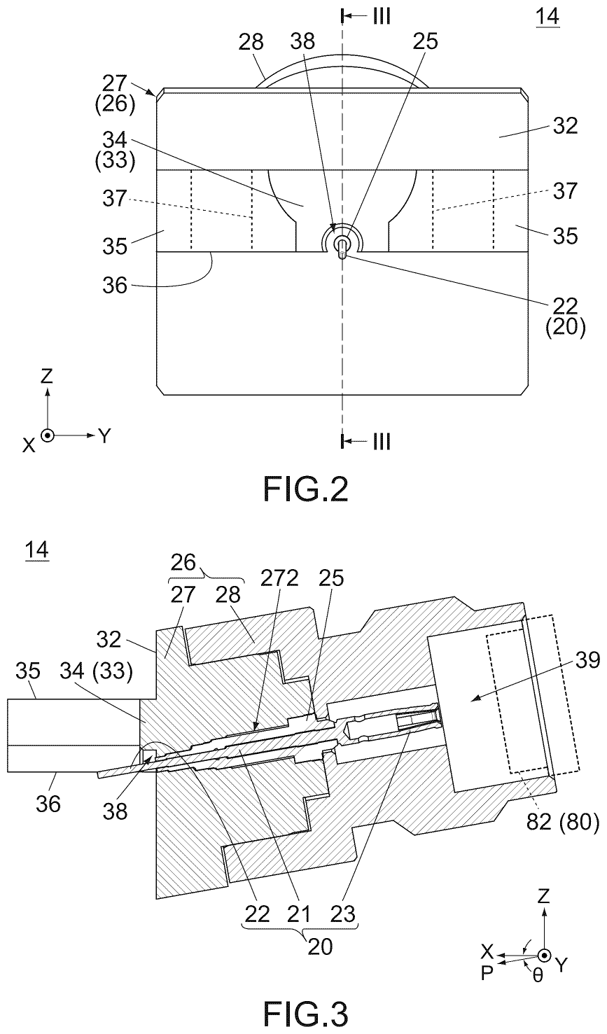

Referring to FIGS. 1 and 2, the projecting portion 33 of the present embodiment is formed with two screw holes 37. In the present embodiment, the two screw holes 37 are formed in the side projecting portions 35, respectively. Each of the screw holes 37 of the present embodiment passes through the side projecting portion 35 in the up-down direction. The screw holes 37 are provided at positions which correspond to those of the passing holes 76 of the board 16 in the horizontal plane, respectively. The thus-arranged two screw holes 37 are apart from each other in the lateral direction and are located at positions same as each other in the front-rear direction. The number of the screw holes 37 of the present embodiment is two. However, the present invention is not limited thereto. For example, in an instance in which the number of the side projecting portions 35 is one, the number of the screw holes 37 may be one. In another instance in which the number of the side projecting portions 35 is three or more, the number of the screw holes 37 may be three or more. Each of the screw holes 37 may be a hole with a ceiling.

The projecting portion 33 has a pressing portion 36. The pressing portion 36 is located at a lower end of the projecting portion 33. The pressing portion 36 of the present embodiment is a flat surface which includes lower surfaces of the middle projecting portion 34 and the side projecting portions 35. The flat surface of the pressing portion 36 extends in parallel to the horizontal plane.

Referring to FIGS. 1 to 3, the outer terminal 26 of the present embodiment is formed with a center hole 38. The center hole 38 is a hole which is formed in a lower end of the middle projecting portion 34. The center hole 38 is located at the middle of the middle projecting portion 34 in the lateral direction and has a half-circular shape in the YZ-plane. The thus-formed center hole 38 is recessed upward from the lower end of the middle projecting portion 34 and opens downward. The center hole 38 extends forward from a front end of the attachment hole 272 along the front-rear direction and opens forward. The two side projecting portions 35 are located at opposite sides of the end surface 32, respectively, with the center hole 38 located therebetween. The contact portion 22 of the center terminal 20 projects forward through the center hole 38 beyond the front end of the middle projecting portion 34.

The end surface 32, the pressing portion 36 and the contact portion 22 of the present embodiment are arranged as described below. Under the pre-connected state, the contact portion 22 extends along the predetermined direction (P-direction) so that at least a part of the contact portion 22 is located forward of the end surface 32 and is located below the pressing portion 36. More specifically, according to the present embodiment, a front end of the contact portion 22 under the pre-connected state is located forward of the end surface 32 and is located below the pressing portion 36. However, the present invention is not limited thereto. For example, under the pre-connected state, the whole of the contact portion 22 may be located forward of the end surface 32 and may be located below the pressing portion 36.

Hereafter, explanation will be made about the plate 40 and the fixing members 60 in this order.

As shown in FIG. 1, the plate 40 of the present embodiment has a rectangular flat-plate shape in parallel to the horizontal plane. In the horizontal plane, the plate 40 has long sides each extending in the lateral direction and short sides each extending in the front-rear direction. The plate 40 has an upper surface and a lower surface each of which is in parallel to the horizontal plane.

The plate 40 has a pressed portion 42. As described later, the pressed portion 42 is a part which is configured to be pressed against the board 16 under the connected state (see FIG. 7). According to the present embodiment, the whole of the upper surface of the plate 40 works as the pressed portion 42.

The plate 40 of the present embodiment is formed with two fixing holes 44. Each of the fixing holes 44 passes through the plate 40 in the up-down direction. Each of the fixing holes 44 has a circular shape in the horizontal plane. The fixing holes 44 are provided at positions which correspond to those of the passing holes 76 of the board 16 in the horizontal plane, respectively. The thus-arranged two fixing holes 44 are apart from each other in the lateral direction and are located at positions same as each other in the front-rear direction.

The plate 40 of the present embodiment has the aforementioned configuration. However, the present invention is not limited thereto. For example, the shape of each of the fixing holes 44 is not specifically limited. The number of the fixing holes 44 may be one, three or more.

The two fixing members 60 of the present embodiment have shapes same as each other. More specifically, each of the fixing members 60 of the present embodiment is a screw 60. Accordingly, each of the fixing members 60 has a head 62 and a threaded shank 64 formed with a thread (not shown). The fixing members 60 are provided so that they correspond to the passing holes 76 of the board 16, respectively. Accordingly, the number of the fixing members 60 of the present embodiment is two. However, the present invention is not limited thereto. For example, the number of the fixing members 60 may be one. The connector assembly 12 may be provided with three or more of the fixing members 60 which have shapes different from each other.

Referring to FIG. 1 together with FIG. 4, the connector assembly 12 and the coaxial connector 14 of the present embodiment are configured to be connected to the board 16 by a connection method described below. The connection method described below is merely an example and can be modified as necessary.

Firstly, the coaxial connector 14, the board 16 and the plate 40 are arranged from top to bottom in this order while the screw holes 37 of the coaxial connector 14, the passing holes 76 of the board 16 and the fixing holes 44 of the plate 40 are arranged at positions same as each other in the horizontal plane. Then, each of the fixing members 60 is screwed into the screw hole 37 through the fixing hole 44 and the passing hole 76.

Referring to FIGS. 4, 6 and 7, as a result of the aforementioned screwing, the board 16 is sandwiched and held between the projecting portion 33 of the coaxial connector 14 and the plate 40 in the up-down direction. The projecting portion 33 is pressed against the board 16 from above, and the plate 40 is pressed against the board 16 from below. The thus-arranged connector assembly 12 and the coaxial connector 14 are under the connected state as shown in FIGS. 4 to 9. Under the connected state, the fixing members 60 fix the projecting portion 33 and the plate 40 to each other so that the board 16 is sandwiched and held between the projecting portion 33 and the plate 40 in the up-down direction.

Referring to FIG. 8, the plate 40 is located below the board 16 under the connected state. Under the connected state, the head 62 of each of the fixing members 60 is pressed against the lower surface of the plate 40 which is in parallel to the horizontal plane and presses the plate 40 upward. The upper surface of the thus-pressed plate 40, which is in parallel to the horizontal plane, presses the board 16 against the pressing portion 36 of the projecting portion 33 which is in parallel to the horizontal plane. As a result, even in an instance in which the board 16 is an easily bendable flexible board, the board 16 is sandwiched and held between the projecting portion 33 and the plate 40 while keeping its posture in which the board 16 extends in parallel to the horizontal plane. The thus-sandwiched board 16 has a contact region which is located under the contact portion 22 of the center terminal 20. The pressed portion 42 of the plate 40 is pressed against this contact region of the board 16 and supports the contact region from below. The thus-supported contact region of the board 16 is not bent even when a force is applied thereto from above.

Referring to FIGS. 5 and 7, the contact portion 22 of the center terminal 20 is located just over the signal line 78 of the board 16 under the connected state. Referring to FIG. 8, under the connected state, the pressing portion 36 presses the upper surface 72 of the board 16 from above, and the contact portion 22 is pressed against and is brought into contact with the signal line 78 of the board 16. Referring to FIGS. 8 and 9, according to the present embodiment, the contact portion 22 is bent so that a front part of the contact portion 22 extends in the front-rear direction which intersects with the predetermined direction (P-direction) and is pressed against the signal line 78 to be in contact with the signal line 78. However, the present invention is not limited thereto. For example, the contact portion 22 may be bent so that the whole of the contact portion 22 extends in a direction which intersects with the predetermined direction and may be pressed against the signal line 78 to be in contact with the signal line 78. Thus, under the connected state, the contact portion 22 may be bent so that at least a part of the contact portion 22 extends in a direction which intersects with the predetermined direction and may be pressed against the signal line 78 to be in contact with the signal line 78.

Referring to FIG. 3, the contact portion 22 of the center terminal 20 under the pre-connected state extends downward beyond the pressing portion 36. Referring to FIG. 8, the pressing portion 36 presses the upper surface 72 of the board 16 from above under the connected state. According to the arrangement described above, the signal line 78 of the board 16 can be arranged at a position same as that of the pressing portion 36 in the up-down direction under the connected state, and thereby the contact portion 22 is pressed against the signal line 78. The contact portion 22 which is pressed against the signal line 78 is resiliently deformed while being bent upward. The contact portion 22 is pressed against the signal line 78, which is supported to be unbendable, from above by a restoring force generated because of the resilient deformation and is securely brought into contact with the signal line 78. Thus, the present embodiment provides the coaxial connector 14 configured to be connected to the board 16 by a new method other than the soldering.

According to the present embodiment, under the connected state, a part of the contact portion 22 which is pressed against and is in contact with the signal line 78 extends linearly along the signal line 78. According to the present embodiment, under the connected state, a part of the contact portion 22 which is pressed against and is in contact with the signal line 78 extends linearly along the front-rear direction. The contact portion 22 which is resiliently deformed as described above can be more securely in contact with the signal line 78. According to the present embodiment, a region at which the contact portion 22 and the signal line 78 are in contact with each other can be made large. However, the present invention is not limited thereto. For example, only the front end of the contact portion 22 may be in contact with the signal line 78.

The coaxial connector 14 seems to be connectable to the board 16 similarly to the present embodiment even in an instance in which the center terminal 20 is arranged to extend along the front-rear direction as a whole while only the contact portion 22 is bent downward. However, according to this instance, the center terminal 20 would receive a rotational force about an axis extending in parallel to the front-rear direction when the contact portion 22 is brought into abutment with the upper surface 72 of the board 16. The center terminal 20 might be rotated because of such a rotational force, and thereby the contact portion 22 might be improperly brought into contact with the signal line 78. In contrast, according to the present embodiment, the whole of the center terminal 20 including the contact portion 22 extends along the predetermined direction (P-direction). According to this configuration, the contact portion 22 can be in contact with the signal line 78 with a sufficient contact force without receiving the aforementioned rotational force.

As previously described, the intersection angle θ between the predetermined direction (P-direction) and the front-rear direction is five degrees or more and is about ten degrees. According to this intersection angle θ, during a process in which the contact portion 22 is brought into contact with the signal line 78, the front end of the contact portion 22 can slide on the signal line 78 while overcoming a friction force. Moreover, only the front part of the contact portion 22 can be in contact with the signal line 78 with a sufficient contact force. According to the present embodiment, the center terminal 20 does not need to be soldered to the board 16. However, the contact portion 22 may be soldered to the signal line 78 after the contact portion 22 is brought into contact with the signal line 78 as described above.

Referring to FIG. 7, according to the present embodiment, the two side projecting portions 35 are fixed to the board 16 under the connected state. The contact portion 22 is located between the two side projecting portions 35 in the lateral direction. According to this arrangement, the contact portion 22 is stably in contact with the signal line 78. However, the present invention is not limited thereto. For example, the coaxial connector 14 may be provided only one of the side projecting portions 35 which is formed with the screw hole 37 in accordance with an instance in which the board 16 is a hardly bendable circuit board. In this instance, the side projecting portion 35 may be located in the vicinity of the contact portion 22 in the lateral direction. In this instance, the board 16 may be formed with only one of the passing holes 76, and the plate 40 may be formed with only one of the fixing holes 44.

According to the present embodiment, under the connected state, the projecting portion 33 is fixed to the board 16 with the screws 60 each of which is screwed into the screw hole 37 of the projecting portion 33 through the passing hole 76 of the board 16. In detail, under the connected state, the projecting portion 33 and the plate 40 are fixed to each other with the screws 60 each of which is screwed into the screw hole 37 of the projecting portion 33 through the fixing hole 44 of the plate 40 and the passing hole 76 of the board 16. Thus, according to the present embodiment, the fixing members 60, or the screws 60, are screwed into the side projecting portions 35 so that the plate 40 is pressed against the board 16. According to this connection method, the pressed portion 42 can be easily and stably pressed against the board 16.

According to the aforementioned connection method, contact reliability between the center terminal 20 and the signal line 78 can be further improved. The aforementioned connection method also prevents bending of a part of the board 16 located between the contact portion 22 and the signal line 78, and thereby contact reliability between the center terminal 20 and the signal line 78 can be improved. Moreover, the coaxial connector 14 and the plate 40 can be detached from the board 16 by merely removing the screws 60. However, the present invention is not limited thereto, but the connection method of the connector assembly 12 to the board 16 can be variously modified as described below.

Each of the side projecting portions 35 may be formed with none of the screw holes 37 while having the pressing portion 36. In this instance, the coaxial connector 14 may have two fixed portions in addition to the side projecting portions 35. Each of the fixed portions may be formed with the screw hole 37 but may be provided with none of the pressing portion 36.

Each of the fixing members 60 does not need to be the screw 60. For example, each of the fixing members 60 may be a hook pin provided on the projecting portion 33. Each of the hook pins may extend downward from the pressing portion 36. In this instance, each of the hook pins may be fixed to the fixing hole 44 through the passing hole 76.

Referring to FIG. 4, each of the fixing members 60 may be a clamp. Each of the clamps may vertically sandwich the plate 40, the board 16 and the coaxial connector 14 so that they are fixed to each other. In this instance, each of the side projecting portions 35 does not need to be formed with the screw hole 37. For example, the coaxial connector 14 of this instance may have two fixed portions in addition to the side projecting portions 35. Each of the fixed portions may be formed with none of the screw holes 37 and may be provided with none of the pressing portion 36. In this instance, each of the clamps may vertically sandwich the plate 40, the board 16 and the fixed portion so that they are fixed to each other.

Referring to FIG. 8 together with FIG. 4, according to the present embodiment, the middle projecting portion 34 is provided, and thereby the signal line 78 of the board 16 can be more reliably prevented from being bent. However, the present invention is not limited thereto. For example, the middle projecting portion 34 does not need to be provided in an instance in which the board 16 is a hardly bendable circuit board.

The plate 40 does not need to be provided in an instance in which the board 16 is a hardly bendable circuit board. In this instance, the connector assembly 12 may comprise only the coaxial connector 14 and the two fixing members 60.

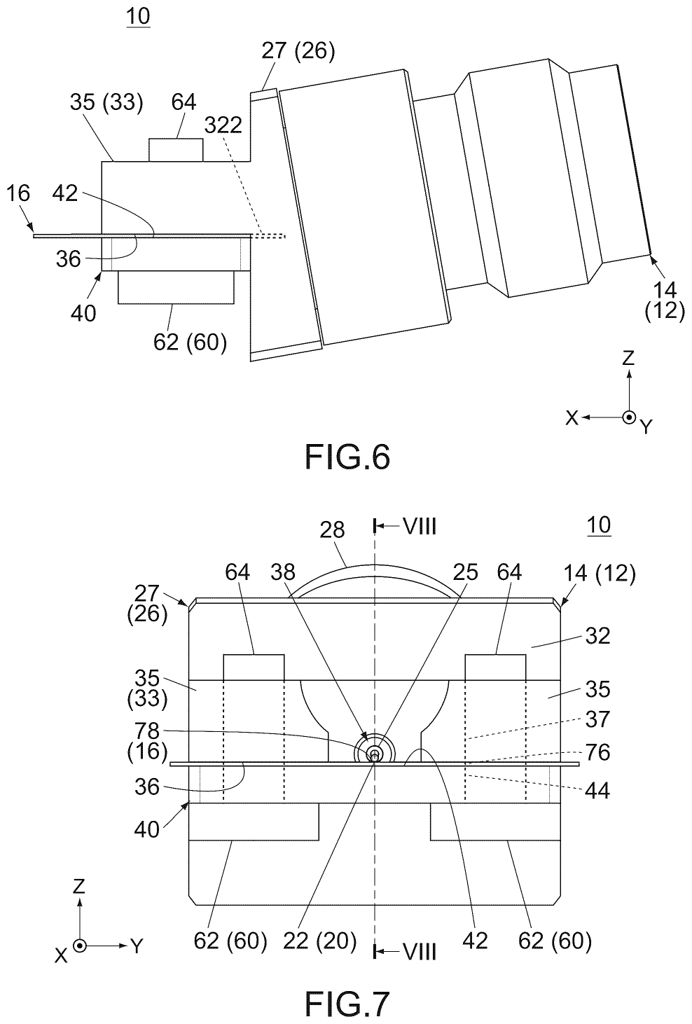

Referring to FIG. 6, the board 16 may be press-fit into a recessed portion 322 so as to be fixed to the coaxial connector 14 in an instance in which the board 16 is a hardly bendable circuit board. The recessed portion 322 may be formed in a part of the outer terminal 26 which is located below the pressing portion 36. The recessed portion 322 may be recessed rearward while extending over all the end surface 32 in the lateral direction. In this instance, the side projecting portions 35, the plate 40 and the fixing members 60 do not need to be provided. Thus, the connector assembly 12 may comprise only the coaxial connector 14.

Referring to FIG. 8, the outer terminal 26 is grounded to the ground layer (not shown) of the lower surface 74 of the board 16 via the projecting portion 33, the fixing members 60 and the plate 40 under the connected state. However, the present invention is not limited thereto, but the grounding method of the outer terminal 26 to the ground layer can be modified as necessary.

The present embodiment can be further variously modified in addition to the already described various modifications.

Referring to FIG. 9, the center terminal 20 may have an additional portion 24. The additional portion 24 may extend upward and forward from the front end of the contact portion 22 so as to intersect with the contact portion 22 under each of the pre-connected state and the connected state.

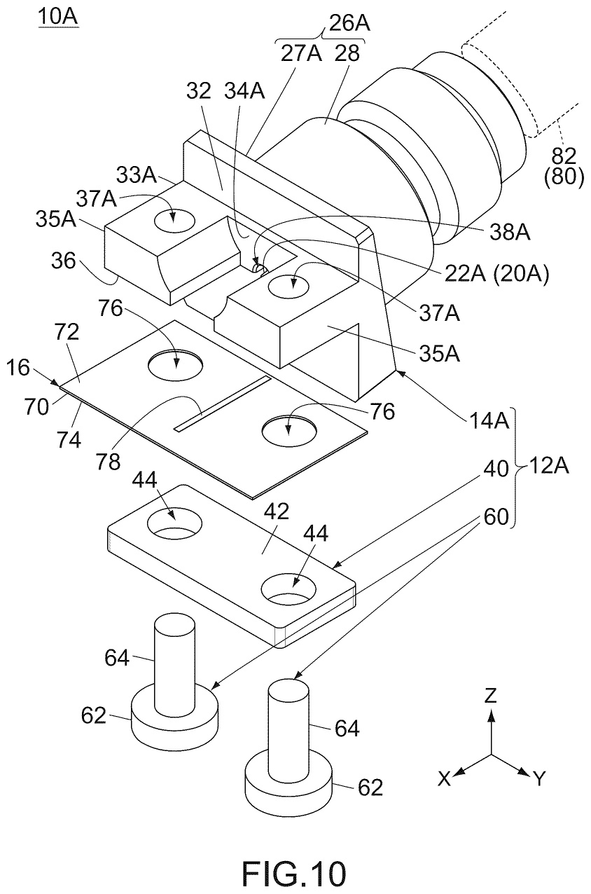

Comparing FIG. 10 with FIG. 1, a structure 10A according to a first modification comprises a connector assembly 12A different from the connector assembly 12 and the board 16 same as that of the structure 10. The connector assembly 12A comprises a coaxial connector 14A different from the coaxial connector 14 of the connector assembly 12 and comprises the plate 40 and the two fixing members 60 same as those of the connector assembly 12. The coaxial connector 14A is configured to be attached to the coaxial cable 80 and to be connected to the board 16 similarly to the coaxial connector 14. Thus, the structure 10A of the present modification is identical to the structure 10 except for the coaxial connector 14A. In particular, the board 16 and the coaxial cable 80 of the present modification are identical to the board 16 and the coaxial cable 80 of the aforementioned embodiment, respectively.

Hereafter, explanation will be made about the coaxial connector 14A, focusing on differences from the coaxial connector 14.

Referring to FIG. 12, the coaxial connector 14A comprises a center terminal 20A made of conductor, an insulation member 25A made of insulator and an outer terminal 26A made of conductor.

The center terminal 20A has a body 21A, a contact portion 22A and the connection portion 23. Comparing FIG. 12 with FIG. 3, the body 21A is shorter than the body 21 of the center terminal 20, and the contact portion 22A is shorter than the contact portion 22 of the center terminal 20. The center terminal 20A has the configuration same as that of the center terminal 20 and is arranged similarly to the center terminal 20 except for these differences. For example, the contact portion 22A and the connection portion 23 are arranged on a single straight line which is an imaginary straight line and extends along the predetermined direction (P-direction). The body 21A is a part covered by the insulation member 25A. The contact portion 22A is resiliently deformable. The connection portion 23 is configured to be connected to the coaxial cable 80. The body 21A extends from the connection portion 23 to the contact portion 22A along the predetermined direction.

The insulation member 25A is shorter than the insulation member 25. The insulation member 25A has the configuration same as that of the insulation member 25 and is arranged similarly to the insulation member 25 except for this difference. For example, the insulation member 25A insulates the outer terminal 26A and the center terminal 20A from each other.

Referring to FIG. 12, the outer terminal 26A comprises a front conductive member 27A and the rear conductive member 28. Comparing FIG. 12 with FIG. 3, the front conductive member 27A has a shape slightly different from that of the front conductive member 27. The outer terminal 26A has the configuration same as that of the outer terminal 26 and is arranged similarly to the outer terminal 26 except for this difference. For example, the front conductive member 27A is combined with the rear conductive member 28 and is located forward of the rear conductive member 28. The front conductive member 27A is in contact with the rear conductive member 28. The outer terminal 26A is formed with the receiving portion 39. The receiving portion 39 is configured to receive the front end 82 of the coaxial cable 80 along the predetermined direction (P-direction) which extends forward and downward.

Referring to FIG. 12, the outer terminal 26A is formed with an attachment hole 272A. The attachment hole 272A opens forward and rearward of the front conductive member 27A. The center terminal 20A is received and attached in the attachment hole 272A so as to extend along the predetermined direction (P-direction).

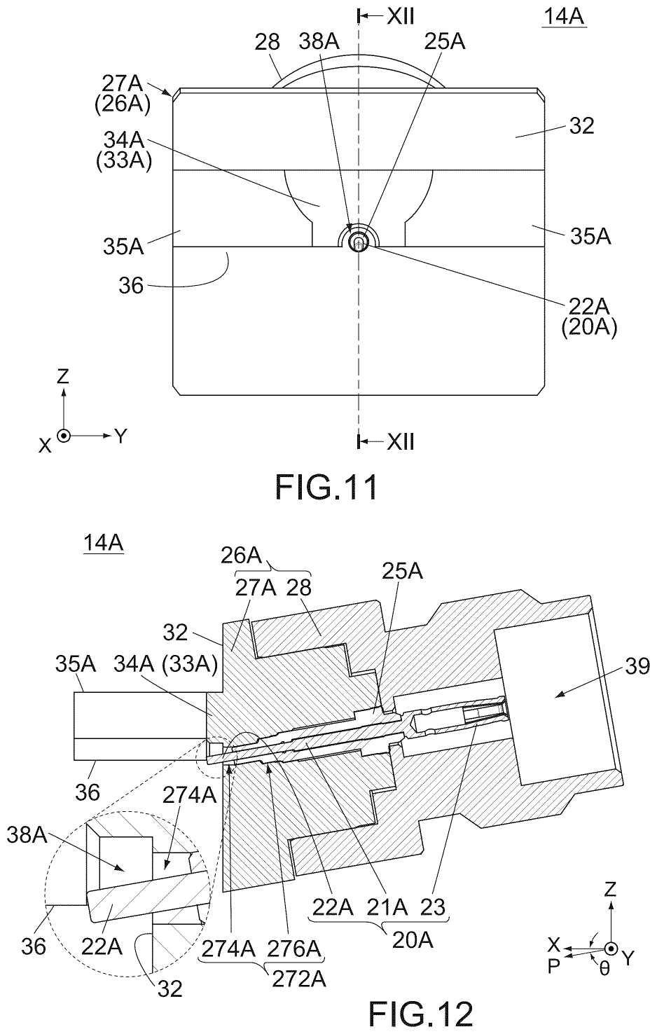

Referring to FIGS. 10 and 11, the outer terminal 26A has a projecting portion 33A and the end surface 32. Comparing FIGS. 10 and 11 with FIGS. 1 and 2, the projecting portion 33A has a size slightly smaller than another size of the projecting portion 33 in the up-down direction. The projecting portion 33A has the configuration same as that of the projecting portion 33 and is arranged similarly to the projecting portion 33 except for this difference.

For example, referring to FIG. 10, the projecting portion 33A projects forward from the end surface 32 and has the pressing portion 36. The pressing portion 36 is located at a lower end of the projecting portion 33A. The projecting portion 33A has a middle projecting portion 34A and two side projecting portions 35A. The middle projecting portion 34A is located at the middle of the projecting portion 33A in the lateral direction and projects forward from the end surface 32. The two side projecting portions 35A are apart from each other with the middle projecting portion 34A located therebetween in the lateral direction and project forward from the end surface 32. The projecting portion 33A is formed with two screw holes 37A. The two screw holes 37A are formed in the side projecting portions 35A, respectively.

Referring to FIGS. 10 to 12, the outer terminal 26A is formed with a center hole 38A. Comparing FIG. 11 with FIG. 2, the center hole 38A has a size slightly smaller than another size of the center hole 38 in the up-down direction. The center hole 38A has the configuration same as that of the center hole 38 and is arranged similarly to the center hole 38 except for this difference. For example, the center hole 38A is recessed upward from a lower end of the middle projecting portion 34A and opens downward. Comparing FIG. 12 with FIG. 3, the center hole 38A extends forward from a front end of the attachment hole 272A along the front-rear direction and opens forward. The contact portion 22A of the center terminal 20A is arranged in a manner different from that of the contact portion 22 of the center terminal 20. More specifically, the contact portion 22A does not extend beyond the center hole 38A but extends to a front end of the center hole 38A.

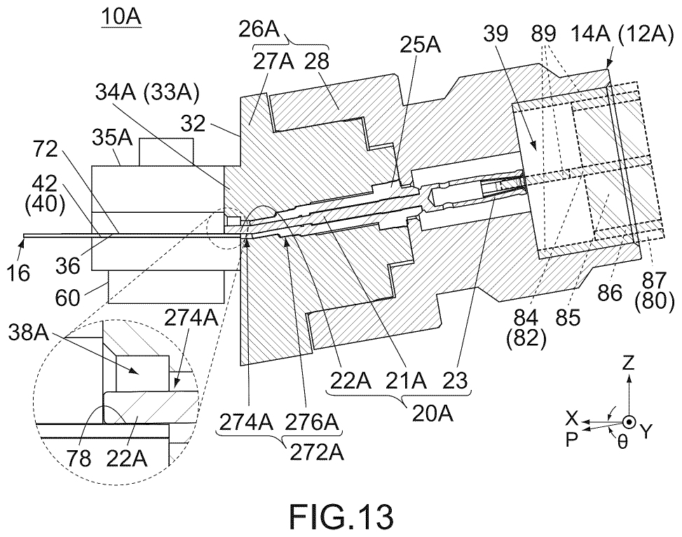

Referring to FIG. 12 together with FIG. 11, under a pre-connected state where the coaxial connector 14A is not yet connected to the board 16, the contact portion 22A of the center terminal 20A extends along the predetermined direction (P-direction) so that at least a part of the contact portion 22A is located forward of the end surface 32 and is located below the pressing portion 36. Referring to FIG. 13, under a connected state where the coaxial connector 14A is fixed and connected to the board 16, the pressing portion 36 presses the upper surface 72 of the board 16 from above, and the contact portion 22A is bent so that at least a part of the contact portion 22A extends in a direction which intersects with the predetermined direction and is pressed against the signal line 78 to be in contact with the signal line 78. The present modification provides the coaxial connector 14A configured to be connected to the board 16 by a new method other than the soldering similarly to the aforementioned embodiment.

The coaxial connector 14A of the present modification is configured to be connected to the board 16 similarly to the aforementioned embodiment. For example, under the connected state, a part of the contact portion 22A which is pressed against and is in contact with the signal line 78 extends linearly along the signal line 78. Under the connected state, the projecting portion 33A is fixed to the board 16 with the screws 60 each of which is screwed into the screw hole 37 (see FIG. 10) of the projecting portion 33A through the passing hole 76 (see FIG. 10) of the board 16. Thus, the two side projecting portions 35A are fixed to the board 16 under the connected state. The contact portion 22A is located between the thus-fixed two side projecting portions 35A in the lateral direction.

Comparing FIG. 12 with FIG. 3, the attachment hole 272A of the present modification is different from the attachment hole 272 and has a front hole 274A and a rear hole 276A. The front hole 274A and the rear hole 276A extend in two directions, respectively, the two directions intersecting with each other. In detail, the rear hole 276A extends along the predetermined direction (P-direction) similarly to the attachment hole 272 and opens rearward of the front conductive member 27A. The rear hole 276A is completely enclosed by the front conductive member 27A of the outer terminal 26A in a predetermined plane perpendicular to the predetermined direction. The front hole 274A extends forward from a front end of the rear hole 276A along the front-rear direction and opens forward of the front conductive member 27A. The front hole 274A is completely enclosed by the front conductive member 27A of the outer terminal 26A in the YZ-plane.

Referring to FIG. 8, when the coaxial connector 14 of the aforementioned embodiment is under the connected state, the body 21 of the center terminal 20 covered by the insulation member 25 is completely enclosed by the outer terminal 26, which has a ground potential, in the predetermined plane perpendicular to the predetermined direction (P-direction). The thus-arranged body 21 has a predetermined characteristic impedance. In contrast, the contact portion 22 of the center terminal 20 projects outward from the outer terminal 26. The thus-arranged contact portion 22 might have a characteristic impedance which is largely different from the characteristic impedance of the body 21. Thus, the characteristic impedance of the contact portion 22 might be unmatched from the characteristic impedance of the body 21.

In contrast, referring to FIG. 13, the insulation member 25A does not extend beyond a rear end of the front hole 274A. Therefore, the body 21A of the center terminal 20A covered by the insulation member 25A does not extend beyond the rear end of the front hole 274A. Thus, when the coaxial connector 14A is under the connected state, the contact portion 22A of the center terminal 20A is exposed outward from a front end of the insulation member 25A and extends in the front hole 274A along the front-rear direction. As a result, the contact portion 22A is completely enclosed by the outer terminal 26A, which has a ground potential, in the YZ-plane. According to this arrangement, the contact portion 22A has a predetermined characteristic impedance similar to that of the body 21A. According to the present modification, difference between the characteristic impedances can be easily reduced.

The contact portion 22A does not extend beyond a front end of the center hole 38A. As a result, when the coaxial connector 14A is under the connected sate, a part of the contact portion 22A which is exposed from the front hole 274A is enclosed by an inner wall surface of the center hole 38A and the ground layer (not shown) formed on the lower surface 74 of the board 16 in the YZ-plane. According to the present modification, difference between the characteristic impedances can be more reliably reduced. However, the present invention is not limited thereto. For example, the contact portion 22A may extend forward beyond the front end of the center hole 38A.

Comparing FIG. 13 with FIG. 8, as can be seen from the explanation described above, the connector assembly 12A is configured to be connected to the board 16 similarly to the connector assembly 12. For example, under the connected state, the fixing members 60 fix the projecting portion 33A and the plate 40 to each other so that the board 16 is sandwiched and held between the projecting portion 33A and the plate 40 in the up-down direction. Under the connected sate, the projecting portion 33A and the plate 40 are fixed to each other with the screws 60 each of which is screwed into the screw hole 37A (see FIG. 10) of the projecting portion 33A through the fixing hole 44 (see FIG. 10) of the plate 40 and the passing hole 76 (see FIG. 10) of the board 16.

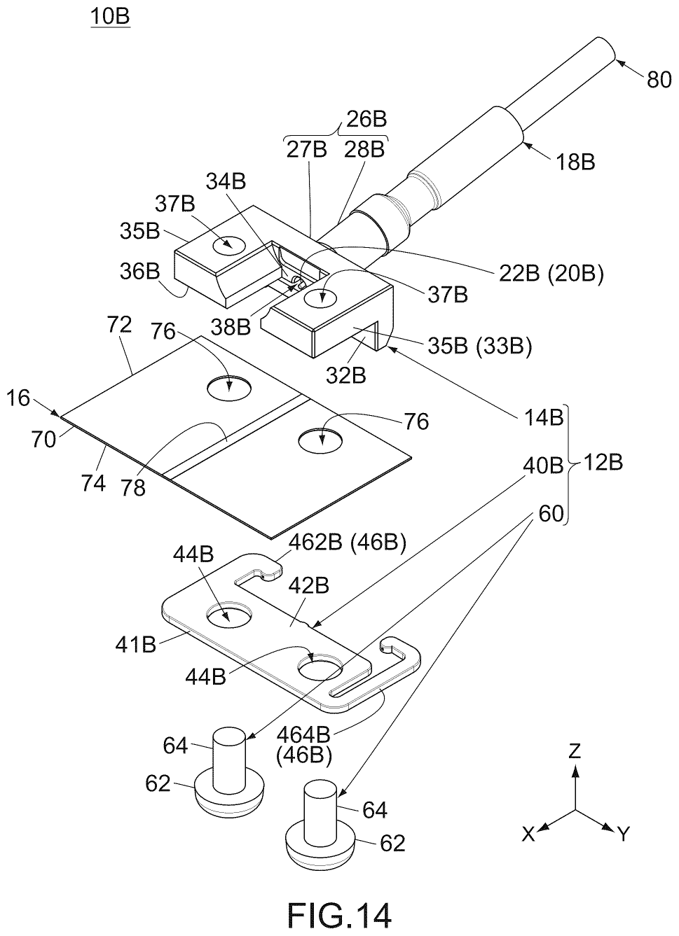

Comparing FIG. 14 with FIG. 1, a structure 10B according to a second modification comprises a connector assembly 12B different from the connector assembly 12 of the structure 10 and the board 16 which has the configuration same as that of the board 16 of the structure 10. The connector assembly 12B comprises a coaxial connector 14B and a plate 40B which are different from the coaxial connector 14 and the plate 40 of the connector assembly 12, respectively, and comprises two fixing members 60 each of which has the configuration same as that of the fixing member 60 of the connector assembly 12. The coaxial connector 14B is configured to be attached to the coaxial cable 80 and to be connected to the board 16 similarly to the coaxial connector 14.

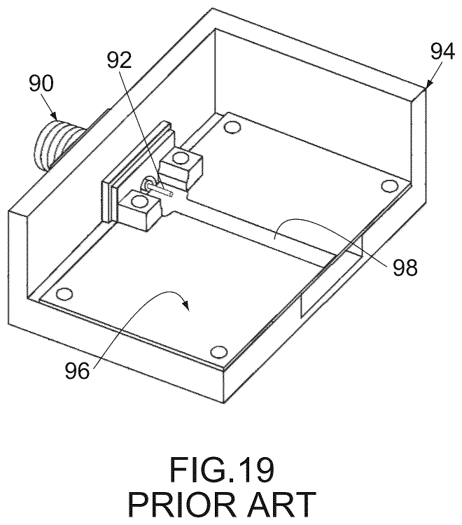

Referring to FIG. 15, the coaxial connector 14B comprises a center terminal 20B made of conductor, an insulation member 25B made of insulator and an outer terminal 26B made of conductor. Referring to FIG. 15 together with FIGS. 14 and 18, the center terminal 20B, the insulation member 25B and the outer terminal 26B are combined together as described later so that the coaxial connector 14B is fabricated.

Hereafter, explanation will be made about the fabricated coaxial connector 14B.

Referring to FIG. 15, the center terminal 20B has a body 21B, a contact portion 22B and a connection portion 23B. The contact portion 22B and the connection portion 23B are arranged on a single straight line which is an imaginary straight line and extends along the predetermined direction (P-direction). The contact portion 22B is resiliently deformable. Referring to FIG. 18, the connection portion 23B is configured to be connected to the coaxial cable 80. The insulation member 25B is attached to the center terminal 20B and insulates the outer terminal 26B and the center terminal 20B from each other. The body 21B is covered by the insulation member 25B and extends from the connection portion 23B to the contact portion 22B along the predetermined direction which extends forward and downward.

Referring to FIGS. 14 and 15, the outer terminal 26B comprises a front conductive member 27B and a rear conductive member 28B. Referring to FIG. 18, the front conductive member 27B is combined with the rear conductive member 28B and is located forward of the rear conductive member 28B. The front conductive member 27B is in contact with the rear conductive member 28B. The outer terminal 26B is formed with a receiving portion 39B. The receiving portion 39B is configured to receive the front end 82 of the coaxial cable 80 along the predetermined direction (P-direction) which extends forward and downward.

The outer terminal 26B is formed with an attachment hole 272B. The attachment hole 272B is formed in the front conductive member 27B. The center terminal 20B is received and attached in the attachment hole 272B so as to extend along the predetermined direction.

The attachment hole 272B has a front hole 274B and a rear hole 276B. The front hole 274B and the rear hole 276B extend in two directions, respectively, the two directions intersecting with each other. In detail, the rear hole 276B extends along the predetermined direction (P-direction) and opens rearward of the front conductive member 27B. The rear hole 276B is completely enclosed by the front conductive member 27B of the outer terminal 26B in a predetermined plane perpendicular to the predetermined direction. The front hole 274B extends forward from a front end of the rear hole 276B along the front-rear direction and opens forward of the front conductive member 27B. The front hole 274B is completely enclosed by the front conductive member 27B of the outer terminal 26B in the YZ-plane.

Referring to FIG. 14, the outer terminal 26B has a projecting portion 33B and an end surface 32B. The projecting portion 33B projects forward from the end surface 32B and has a pressing portion 36B. The pressing portion 36B is located at a lower end of the projecting portion 33B.

The projecting portion 33B has a middle projecting portion 34B and two side projecting portions 35B. The middle projecting portion 34B is located at the middle of the projecting portion 33B in the lateral direction and projects forward from the end surface 32B. The two side projecting portions 35B are apart from each other with the middle projecting portion 34B located therebetween in the lateral direction and project forward from the end surface 32B. The projecting portion 33B is formed with two screw holes 37B. The two screw holes 37B are formed in the side projecting portions 35B, respectively.

Referring to FIGS. 14 and 18, the outer terminal 26B is formed with a center hole 38B. The center hole 38B is recessed upward from a lower end of the middle projecting portion 34B and opens downward. The center hole 38B extends forward from a front end of the front hole 274B along the front-rear direction and opens forward. The contact portion 22B of the center terminal 20B does not extend beyond the center hole 38B but extends to a front end of the center hole 38B.

Referring to FIG. 15 together with FIG. 18, the coaxial connector 14B is fabricated as described below. However, the fabrication method described below is merely an example and can be modified as necessary.

Firstly, the center terminal 20B is inserted into the insulation member 25B. Then, the front end 82 of the coaxial cable 80 is inserted into a rear part of the receiving portion 39B of the rear conductive member 28B. Meanwhile, the core wire 84 of the coaxial cable 80 is connected to the connection portion 23B of the center terminal 20B, and the shield 86 of the coaxial cable 80 is connected to the rear conductive member 28B.

Then, the rear conductive member 28B and the coaxial cable 80 are fixed to each other with a tube 18B. The tube 18B is made of material which is shrunk and hardened when heated. The tube 18B has a cylindrical shape under its initial state. The tube 18B is attached to the rear conductive member 28B and the coaxial cable 80 so as to enclose a rear part of the rear conductive member 28B and a front part of the coaxial cable 80. Then, the tube 18B is heated to be shrunk and hardened. As a result, the rear conductive member 28B and the coaxial cable 80 are fixed to each other.

Then, the rear conductive member 28B is attached to a rear part of the front conductive member 27B. The thus-attached rear conductive member 28B encloses the rear part of the front conductive member 27B in the predetermined plane perpendicular to the predetermined direction (P-direction). Meanwhile, the center terminal 20B is inserted into the rear hole 276B of the attachment hole 272B formed in the front conductive member 27B together with the insulation member 25B.

The coaxial connector 14B which is fabricated as described above is bonded to the coaxial cable 80 and cannot be detached from the coaxial cable 80 unless the tube 18B is broken.

Comparing FIG. 14 with FIG. 1, the coaxial connector 14B has a configuration similar to that of the coaxial connector 14 under a pre-connected state where the coaxial connector 14B is not yet connected to the board 16 as shown in FIGS. 14 and 18. For example, referring to FIG. 14 together with FIG. 18, under the pre-connected state, the contact portion 22B of the center terminal 20B extends along the predetermined direction (P-direction) so that at least a part of the contact portion 22B is located forward of the end surface 32B and is located below the pressing portion 36B.

Comparing FIG. 14 with FIG. 1, the coaxial connector 14B is configured to be connected to the board 16 using the plate 40B and the fixing members 60 similarly to the coaxial connector 14. Hereafter, explanation will be made about the plate 40B.

As shown in FIG. 14, the plate 40B has a flat-plate shape in parallel to the horizontal plane. The plate 40B has a main portion 41B and two arms 46B. The main portion 41B has a rectangular flat-plate shape in the horizontal plane and has two long sides each extending in the lateral direction and two short sides each extending in the front-rear direction.

The two arms 46B includes a first arm 462B and a second arm 464B. The first arm 462B extends rearward from an end of the front long side of the main portion 41B in the lateral direction. The first arm 462B has a rear end which projects inward in the lateral direction. The second arm 464B slightly projects outward in the lateral direction from an end of the rear long side of the main portion 41B in the lateral direction and then extends rearward. The second arm 464B has a rear end which projects inward in the lateral direction. The rear end of the first arm 462B and the rear end of the second arm 464B extend toward each other in the lateral direction.

The plate 40B has a pressed portion 42B. The plate 40B is formed with two fixing holes 44B. The pressed portion 42B is a part of an upper surface of the plate 40B. Each of the fixing holes 44B passes through the plate 40B in the up-down direction.

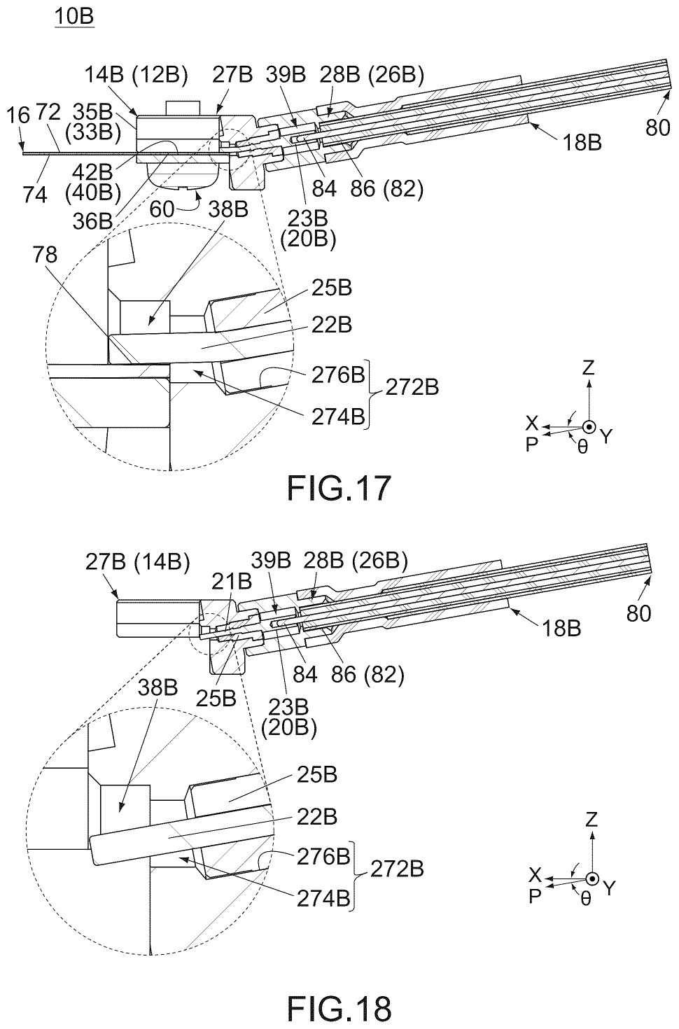

Referring to FIG. 14 together with FIG. 17, the connector assembly 12B and the coaxial connector 14B are configured to be connected to the board 16 by a connection method described below.

Firstly, the coaxial connector 14B, the board 16 and the plate 40B are arranged from top to bottom in this order while the screw holes 37B of the coaxial connector 14B, the passing holes 76 of the board 16 and the fixing holes 44B of the plate 40B are arranged at positions same as each other in the horizontal plane. Then, each of the fixing members 60 is screwed into the screw hole 37B through the fixing hole 44B and the passing hole 76.

As a result of the aforementioned screwing, each of the connector assembly 12B and the coaxial connector 14B takes a connected sate where it is fixed and connected to the board 16 as shown in FIGS. 16 and 17. Under the connected sate, the pressing portion 36B of the projecting portion 33B presses the upper surface 72 of the board 16 from above, and the contact portion 22B of the center terminal 20B is bent so that at least a part of the contact portion 22B extends in a direction which intersects with the predetermined direction (P-direction) and is pressed against the signal line 78 of the board 16 to be in contact with the signal line 78. The present modification provides the coaxial connector 14B configured to be connected to the board 16 by a new method other than the soldering.

According to the present modification, under the connected state, a part of the contact portion 22B which is pressed against and is in contact with the signal line 78 extends linearly along the signal line 78. The contact portion 22B which is resiliently deformed as described above is more securely in contact with the signal line 78.

According to the present modification, the two side projecting portions 35B are fixed to the board 16 under the connected state. The contact portion 22B is located between the two side projecting portions 35B in the lateral direction. According to this arrangement, the contact portion 22B is stably in contact with the signal line 78.

Each of the fixing members 60 of the present modification is a screw 60. According to the present modification, under the connected state, the projecting portion 33B is fixed to the board 16 with the screws 60 each of which is screwed into the screw hole 37B of the projecting portion 33B through the passing hole 76 of the board 16. The coaxial connector 14B can be securely fixed to the board 16 by the aforementioned simple method.

Comparing FIG. 17 with FIG. 8, as can be seen from the explanation described above, the connector assembly 12B is configured to be connected to the board 16 similarly to the connector assembly 12. For example, under the connected state, the fixing members 60 fix the projecting portion 33B and the plate 40B to each other so that the board 16 is sandwiched and held between the projecting portion 33B and the plate 40B in the up-down direction. Under the connected state, the projecting portion 33B and the plate 40B are fixed to each other with the screws 60 each of which is screwed into the screw hole 37B (see FIG. 14) of the projecting portion 33B through the fixing hole 44B (see FIG. 14) of the plate 40B and the passing hole 76 (see FIG. 14) of the board 16.

Referring to FIG. 17, according to the present modification, the contact portion 22B of the center terminal 20B is exposed outward from a front end of the insulation member 25B and extends in the front hole 274B along the front-rear direction. According to this arrangement, difference between the characteristic impedance of the body 21B and the characteristic impedance of the contact portion 22B can be easily reduced. The contact portion 22B of the present modification does not extend beyond the front end of the center hole 38B. According to this arrangement, difference between the characteristic impedances can be more reliably reduced.

Referring to FIG. 16 together with FIG. 8, under the connected state, the outer terminal 26B of the present modification is grounded to the ground layer (not shown) of the lower surface 74 of the board 16 via the projecting portion 33B, the fixing members 60 and the plate 40B similarly to the outer terminal 26. The outer terminal 26B is also grounded to the ground layer only via the plate 40B under the connected state.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A coaxial connector configured to be attached to a coaxial cable and to be connected to a board, wherein:
the board extends along a horizontal plane and has an upper surface in an up-down direction perpendicular to the horizontal plane, the upper surface being formed with a signal line, the signal line extending in a front-rear direction perpendicular to the up-down direction;
the coaxial connector comprises an outer terminal, a center terminal and an insulation member;
the insulation member insulates the outer terminal and the center terminal from each other;
the outer terminal is formed with a receiving portion;
the receiving portion is configured to receive a front end of the coaxial cable along a predetermined direction which extends forward and downward;
the outer terminal has a projecting portion and an end surface;
the projecting portion projects forward from the end surface and has a pressing portion;
the pressing portion is located at a lower end of the projecting portion;
the center terminal has a contact portion and a connection portion;
the contact portion and the connection portion are arranged on a single straight line which extends along the predetermined direction;
the contact portion is resiliently deformable;
the connection portion is configured to be connected to the coaxial cable;
under a pre-connected state where the coaxial connector is not yet connected to the board, the contact portion extends along the predetermined direction so that at least a part of the contact portion is located forward of the end surface and is located below the pressing portion; and
under a connected state where the coaxial connector is connected to the board, the pressing portion presses the upper surface of the board from above, and the contact portion is bent so that at least a part of the contact portion extends in a direction which intersects with the predetermined direction and is pressed against the signal line of the board to be in contact with the signal line.

2. The coaxial connector as recited in claim 1, wherein:
the projecting portion is formed with a screw hole;
the board is formed with a passing hole; and
under the connected state, the projecting portion is fixed to the board with a screw which is screwed into the screw hole of the projecting portion through the passing hole of the board.

3. The coaxial connector as recited in claim 1, wherein:
the outer terminal is formed with an attachment hole;
the center terminal is attached in the attachment hole so as to extend along the predetermined direction;
the attachment hole has a front hole and a rear hole;
the rear hole extends along the predetermined direction; and
the front hole extends from a front end of the rear hole along the front-rear direction and opens forward.

4. The coaxial connector as recited in claim 1, wherein under the connected state, a part of the contact portion which is pressed against and is in contact with the signal line extends linearly along the signal line.

5. The coaxial connector as recited in claim 1, wherein:
the projecting portion has two side projecting portions;
the two side projecting portions are apart from each other in a lateral direction perpendicular to both the front-rear direction and the up-down direction;
the two side projecting portions are fixed to the board under the connected state; and
the contact portion is located between the two side projecting portions in the lateral direction.

6. The coaxial connector as recited in claim 1, wherein:
the center terminal has a body; and
the body extends from the connection portion to the contact portion along the predetermined direction.

7. A connector assembly comprising the coaxial connector as recited in claim 1, a plate and a fixing member, wherein under the connected state, the fixing member fixes the projecting portion and the plate to each other so that the board is sandwiched and held between the projecting portion and the plate in the up-down direction.

8. The connector assembly as recited in claim 7, wherein:
the projecting portion is formed with a screw hole;
the plate is formed with a fixing hole;
the board is formed with a passing hole;
the fixing member is a screw; and
under the connected state, the projecting portion and the plate are fixed to each other with the screw which is screwed into the screw hole of the projecting portion through the fixing hole of the plate and the passing hole of the board.

9. A connector assembly comprising the coaxial connector as recited in claim 2, a plate and a fixing member, wherein under the connected state, the fixing member fixes the projecting portion and the plate to each other so that the board is sandwiched and held between the projecting portion and the plate in the up-down direction.

10. The connector assembly as recited in claim 9, wherein:
the plate is formed with a fixing hole;
the fixing member is a screw; and
under the connected state, the projecting portion and the plate are fixed to each other with the screw which is screwed into the screw hole of the projecting portion through the fixing hole of the plate and the passing hole of the board.
